(19) United States
(12) Patent Application Publication
(10) Pub. No.: US 2013/0047209 A1
(43) Pub. Date: Feb. 21, 2013

(54) AUTHENTICATION PROCESSING METHOD AND APPARATUS

(71) Applicants: Akashi SATOH, Tsukuba-shi (JP); Toshihiro Katashita, Tsukuba-shi (JP)

(72) Inventors: Akashi SATOH, Tsukuba-shi (JP); Toshihiro Katashita, Tsukuba-shi (JP)

(73) Assignee: National Institute of Advanced Industrial Science and Technology, Chiyoda-ku (JP)

(21) Appl. No.: 13/615,763

(22) Filed: Sep. 14, 2012

Related U.S. Application Data
(63) Continuation of application No. PCT/JP2011/056706, filed on Mar. 22, 2011.

(30) Foreign Application Priority Data
Mar. 24, 2010 (JP) 2010-067237

(51) Int. Cl. G06F 21/00

(52) U.S. Cl. 726/2

(57) ABSTRACT

A physical unclonable function (PUF) device, and a PUF reader which extracts PUF parameters required to calculate a response output from a challenge input by analyzing an operation of the PUF device. Operation parameters characterizing an operation state are obtained by observing a power waveform, an electromagnetic waveform, or a processing time of the PUF device at that time. Authentication of the PUF device is based on the extracted parameters. The PUF reader executes authenticity determination as to whether or not the PUF device is a valid PUF device by monitoring an operation of the PUF device during response generation based on the operation parameters.

### TECHNICAL FIELD

The present invention relates to an authentication processing method and apparatus, which execute device authentication by reading parameters recorded in a PUF device using a PUF reader.

### BACKGROUND ART

A biometric technique implements personal authentication by way of the fact that biological information such as a fingerprint and iris pattern is different for each person. By contrast, a study for preventing forgery by finding different physical characteristics for each artifact has been extensively made. For example, digital data recorded on a magnetic card is easily copied intact, but it is very difficult to entirely copy even an analog magnetic intensity pattern. A function that cannot artificially control parameters is called a PUF (Physical Unclonable Function). An implementation method of a PUF function in an LSI is to obtain individually different outputs for a certain input using individually and subtly different signal propagation delays, switching delays of transistor gates, and the like due to manufacturing variations [NPL1].

FIG. 4 shows an Arbiter PUF as a most basic circuit [NPL2]. 2:1 selectors are connected in series, and switches of the selectors are controlled by an input bit sequence called “challenge” so as to obtain an output “0” or “1”, called “response”. A leading edge of one signal, which is input from the left side of the circuit, reaches a circuit called “Arbiter” via two routes, and an output is settled by detecting which of upper and lower inputs reaches earlier. In FIG. 4, as the Arbiter, a register which fetches data in response to a leading edge of a clock is used. When a lower clock input goes High earlier than an upper input D which changes from Low (0) to High (1), “0” is output to Q. When a clock goes High after D goes High, “1” is output. Which of the inputs reaches the destination earlier depends on circuit characteristics caused by LSI process variations and signal routes selected by the challenge bit pattern.

FIG. 5 shows a Ring Oscillator PUF which uses variations of operation frequencies of ring oscillators [NPL3]. A plurality of oscillators based on the same layout are prepared, and a signal for selecting two out of these oscillators is input as “Challenge”. The numbers of switching times of the oscillators are counted within a given time period, and the counts are compared to return a response “0” or “1”. The operation is stable compared to the Arbiter PUF, but the Ring Oscillator PUF takes much time from input of “Challenge” until the response is returned as a demerit.

An SRAM PUF uses randomness as to whether a latch of each memory cell is “0” or “1” at power-ON timing. A device FPGA (Field Programmable Gate Array), which has prevailed in recent years, and the circuit function of which is reconfigurable, also incorporates an SRAM, but it is normally impossible to use the SRAM as the PUF function since its data is cleared at activation timing. Thus, a Butterfly PUF uses two registers, which are cross-coupled, as shown in FIG. 6, as an SRAM memory [NPL4], and can be incorporated in the FPGA. In the registers shown in FIG. 6, inputs PRE and CLR are signals required to preset outputs Q to “1” or to clear them to “0”. Since an input “Excite” connected to these signals is changed from “0” to “1” while supplying clocks, input and output data of the registers are reversed, resulting in an unstable state. By falling Excite to “0” after several clocks, a state of Out is settled.

As a characteristic feature of the PUF function, it is physically impossible to copy that function. However, an operation of a simple PUF function can be simulated by observing a plurality of challenges and responses. For example, in the Arbiter PUF shown in FIG. 4, which of the upper and lower signals reaches the Arbiter earlier can be estimated by simply adding paths of signals to the challenge as long as delays in the respective selectors can be detected. In the Ring Oscillator PUF shown in FIG. 5, since the frequencies of the two oscillators are compared to obtain a response, the frequencies of the oscillators can be ranked from the response. Hence, in order to make the challenge and response difficult to be analyzed, various improvements have been proposed. For example, as shown in FIG. 7(a), a feedforward path may be added to the Arbiter PUF to provide nonlinearity. Also, as shown in (b), outputs from a plurality of PUF circuits may be XORed or more complicated calculations such as a Hush function may be applied to the outputs.

FIG. 8 shows a general use method of the PUF device. An administrator of a system using a PUF device measures a plurality of challenge-response relationships, and records them in a database before distribution of a PUF device to the user. In order to confirm if a distributed PUF device is authentic, the user requests the administrator to issue a challenge, generates a response to that challenge using the PUF device, and returns that response. The administrator determines if the PUF device is authentic by comparing the returned response with that in the database. Using the same challenge, a third person who monitored this communication may imitate the original PUF using the previous response. Hence, a challenge and response in the database, having been used once, are deleted.

Since the PUF function uses subtle characteristic variations of a device, the same response is not always returned to the same challenge depending on use environments. Hence, a method of adding parity based on an ECC (Error Control Code) upon generation of a database has been proposed [PTL1]. The user receives this parity together with a challenge, corrects an output from a PUF device using this parity if that output includes a correctable error, and returns the corrected output to the administrator.

### CITATION LIST

### Patent Literature

PTL1: US 2008279393(A1)

### Non-Patent Literature

NPL1: R. S. Pappu, “Physical one-way functions,” PhD thesis, MIT, March 2001, http://pubs.media.mit.edu/pubs/papers/01.03.pappuphd.po wf.pdf.
NPL2: N. Gassend, et al., “Silicon physical random functions,” Proc. 9th ACM Conference on Computer and Communication Security (CCS'02), pp. 148-160, November 2002.
NPL3: G. E. Suh, et al., “Physical Unclonable Functions for Device Authentication and Secret Key Generation,” Proc. Design Automation Conference (DAC 2007), pp. 9-14, June 2007.
NPL4: S. S. Kumar, et al., “Extended Abstract: The Butterfly PUF Protecting IP on every FPGA,” Proc. IEEE Int. Workshop on Hardware-Oriented Security and Trust 2008 (HOST 2008), pp. 67-70, June, 2008.

### SUMMARY OF INVENTION

### Technical Problem

Since the PUF uses uncontrollable variations of physical characteristics although its concept is simple, various problems to be solved are posed in practical use. These problems are summarized below.
(1) A simple structure of PUF circuit is at a risk for simulation.
(2) Complication of PUF circuit results in lower performance (for example, increases in circuit scale, power consumption, and processing time).
(3) Complication of PUF circuit results in an unstable output, and requires an ECC.
(4) A database has to be generated in advance and saved in a server, which prevent local authentication.
(5) A database can no longer be used if it is used up.

Therefore, the present invention has as its object to solve these problems, and to achieve the following points.
(1) A forged PUF device is identified while using a simple structure of PUF circuit.
(2) The simple structure of a PUF circuit is not modified so as not to lower processing performances.
(3) A high accuracy is obtained without using any ECC.
(4) Local authentication is executed without using any database managed by a server.
(5) The number of use of a PUF device has no limitation.

### Solution to Problem

An authentication processing method and apparatus of the present invention comprise a PUF device, and a PUF reader which analyzes an operation of the PUF device to extract PUF parameters required to calculate a response output from a challenge input and to extract operation parameters characterizing an operation state by observing a power waveform, an electromagnetic waveform, or processing time of the PUF device at that time, and authenticates the PUF device based on the extracted parameters. The PUF reader generates a challenge C, transmits it to the PUF device, and calculates a first response R expected for the challenge C based on the PUF parameters. The PUF device generates a second response R′ based on the challenge C transmitted from the PUF reader, and transfers this second response R′ to the PUF reader. The PUF reader executes authentication processing by comparing the second response R′ with the preliminarily calculated first response R. The PUF reader executes authenticity determination as to whether or not the PUF device is a valid PUF device by monitoring the operation of the PUF device during response generation based on the operation parameters.

The PUF parameters and operation parameters are extracted by the PUF reader or by an independent PUF measurement apparatus arranged to extract these parameters. The PUF parameters are those which are saved by acquiring some pairs of challenges and responses in the PUF device, or are parameters required to calculate a response from a challenge. The saved PUF parameters and operation parameters are saved in the PUF reader to execute local device authentication, or are saved on a PUF server, which makes communications via the PUF reader, when they are used.

A digital signature is applied to the saved PUF parameters and operation parameters so as to prevent falsification. The PUF reader verifies the digital signature applied to the parameters transferred from the PUF device to confirm valid parameters. If signature verification has failed, the PUF reader aborts authentication processing.

### Advantageous Effects of Invention

Effects of the present invention will be described below in correspondence with the problems to be solved.
(1) A forged PUF device is identified using a simple structure of PUF circuit.

Since a challenge-response pattern is allowed to be monitored by a third person, a simple PUF circuit can be used. The PUF reader observes a processing time and a power/electromagnetic waveform when the PUF device generates a response, and discriminates whether that PUF device is a valid PUF device or simulating device. Since this discrimination is made by the PUF reader, no special function is required for the PUF device. It is recommended to apply a signature to parameters of the PUF device. However, since the signature can be generated outside the PUF device at an initialization timing and the verification is made by the PUF reader, no circuit for signature/verification is required for the PUF device.

(2) The simple structure of a PUF circuit is not modified so as not to lower processing performances.

A PUF circuit, which does not require any change and is simple to allow parameterization, is suitable for the present invention. For this reason, in the present invention, no penalty of a processing speed of response generation of the PUF device is generated.

(3) A high accuracy is obtained without using any ECC.

When a response includes a few errors, challenge-response processing is repeated in place of judgment by single authentication, thereby improving accuracy of determination as to whether these errors are accidental errors due to an operation environment or the like or a response from a different device (it has already been confirmed based on a processing time and power/electromagnetic waveform that the PUF device is not a simulating device before response comparison). Alternatively, the accuracy can be improved by extracting parameters in consideration of the influence of an operation environment or the like or holding challenge-response data corresponding to one-to-many responses.

(4) Local authentication is executed without using any database managed by a server.

Since challenge-response parameters can be recorded in a memory of the PUF device, local authentication can be executed with the PUF reader. For this reason, authentication data management cost and communication cost of the device can be suppressed. Of course, authentication can be executed by managing all parameters by a server without recording any parameters in the PUF device.

(5) The number of use of a PUF device has no limitation.

Since a challenge-response can be re-used and no problem is posed if parameters are detected by a third person, the number of use of a PUF device has no limitation.

### BRIEF DESCRIPTION OF DRAWINGS

FIG. 1 is a view showing a first example of an authentication method based on a PUF, which embodies the present invention;

FIG. 2 is a view showing a second example of the authentication method based on the PUF, which embodies the present invention;

FIG. 3 is a view showing a third example of the authentication method based on the PUF, which embodies the present invention;

FIG. 4 is a view showing an Arbiter PUF as a most basic circuit;

FIG. 5 is a view showing a Ring Oscillator PUF which uses operation frequency variations of ring oscillators;

FIG. 6 is a view showing a Butterfly PUF in which two registers are cross-coupled and are used as an SRAM memory cell;

FIG. 7 includes views showing variations of a PUF circuit;

FIG. 8 is a view for explaining a use method of a PUF device; and

FIG. 9 is a view for explaining use of an ECC.

### DESCRIPTION OF EMBODIMENTS

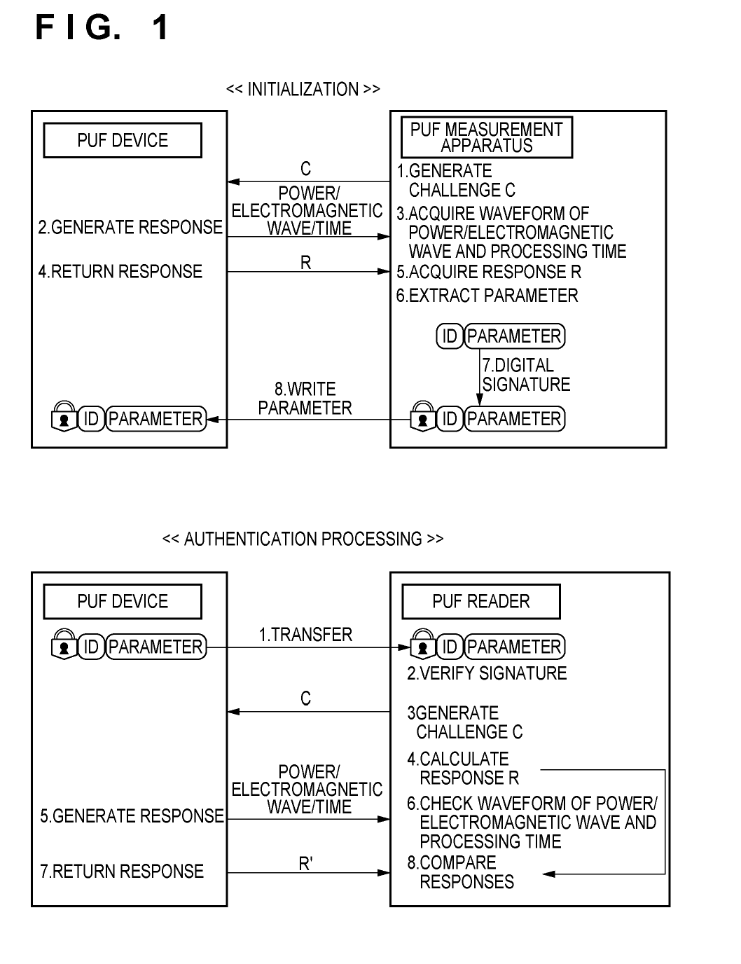

FIG. 1 is a view showing a first example of an authentication method based on a PUF, which embodies the present invention. In the present invention, in place of generation of a challenge-response database, parameters required to calculate a response output from a challenge input are extracted by analyzing the operation of a PUF device. That is, use of a PUF device which allows simulation and has a simple function is suitable contrary to a normal PUF device to which various devises are applied to prevent simulation.

When such parameters that allow to calculate a challenge-response relationship of the PUF (to be referred to as PUF parameters hereinafter) cannot be acquired, some pairs of challenges and responses are acquired, and are saved as PUF parameters. At the same time, operation features such as a power or radiated electromagnetic waveform, and processing time at the time of response generation are saved as parameters (to be referred to as operation parameters hereinafter). The operation parameters such as the power/electromagnetic waveform and processing time need not always be observed for each PUF device, and those which represent operation features of the whole PUF devices which are manufactured by the same LSI process to have the same circuit may be used. This operation feature checking processing corresponds to, for example, biological identification in a fingerprint comparator. Biological authentication does not record each individual's biological information, and uses information which allows biological identification of fingers for unspecified persons. Likewise, the present invention can use feature patterns of the whole PUF devices of the same type as operation parameters without recording patterns of power/electromagnetic wave and processing times of individual PUF devices.

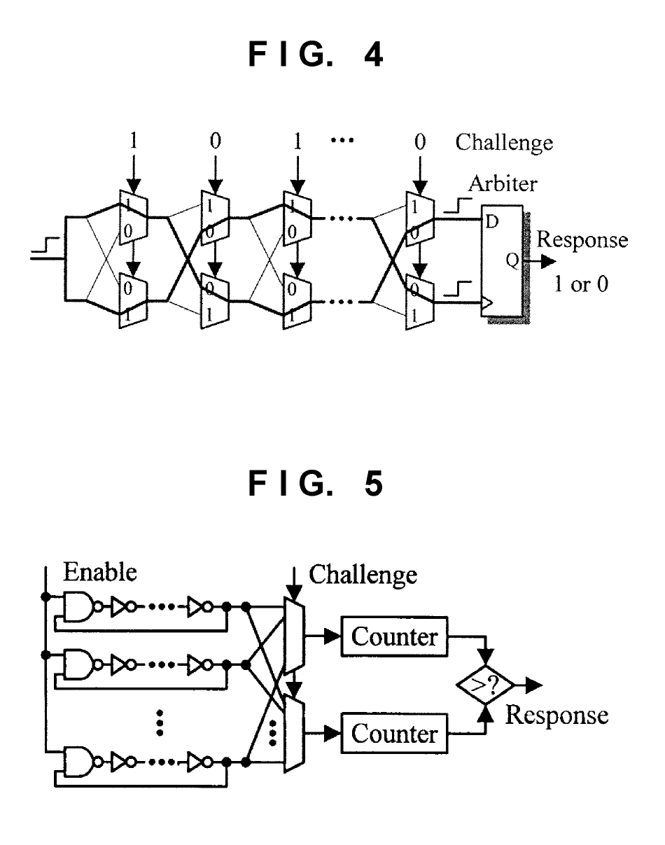

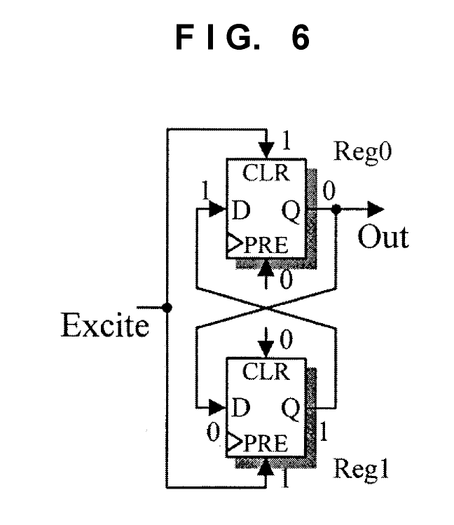

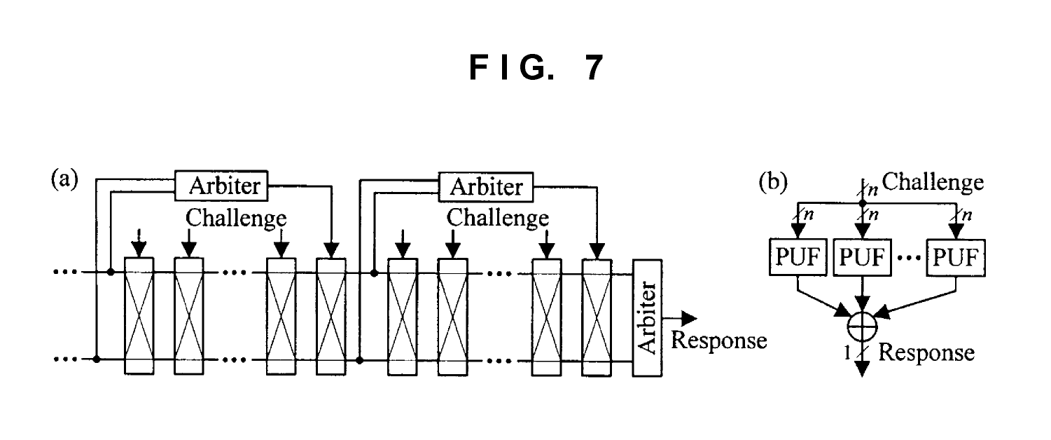

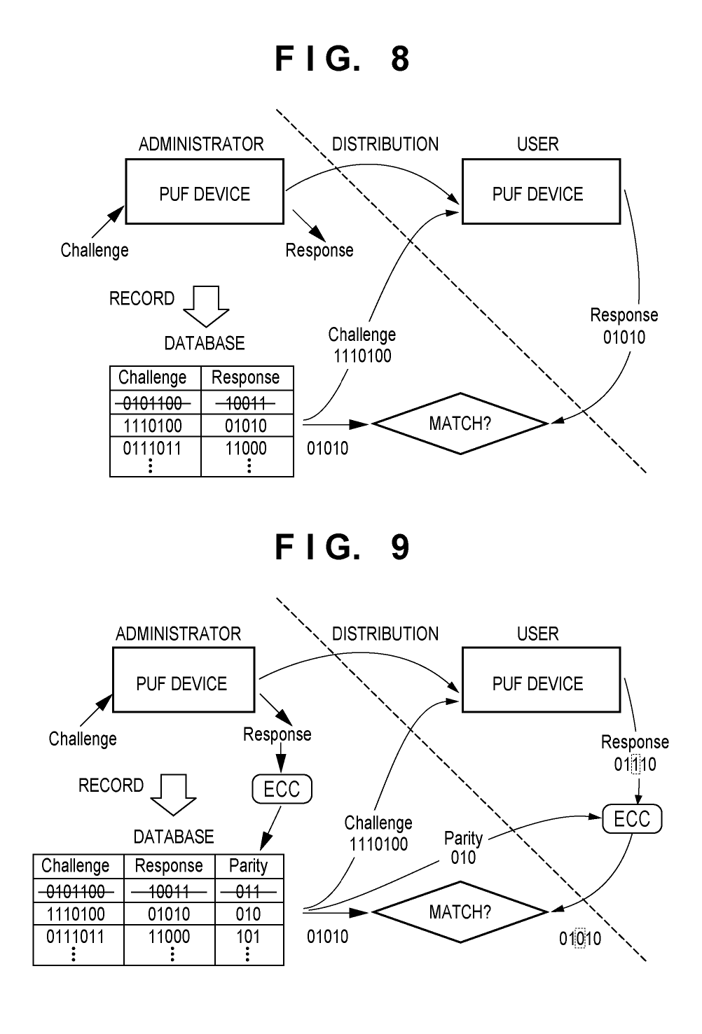

These PUF parameters and operation parameters are recorded in the PUF device to execute local device authentication between the PUF device and PUF reader. In FIGS. 1 to 4, the PUF parameters and operation parameters are described together as “parameters” for the sake of simplicity, and “parameters” simply described in the following description are used in the same meaning. The parameters include not only numerical values but also calculation formulas and the like which represent PUF features. The PUF reader does not extract the parameters of the PUF device, but it loads the parameters, which are measured and saved in advance, and checks whether or not the PUF device makes operations which match the loaded parameters. In local authentication without using any server, since the PUF reader loads the parameters from the PUF device to execute processing, a digital signature is applied to the parameters in the PUF device so as to prevent falsification by an attacker (see FIG. 1). Note that encryption can also prevent falsification by a third party in place of a digital signature. Since signature generation is executed by a PUF measurement apparatus at an initialization timing, and verification is executed by the PUF reader, the PUF device itself can be a very compact, simple implementation which has only a PUF circuit and a small memory required to save the parameters.

The initialization sequence of the PUF device will be described first with reference to FIG. 1.

1. A PUF parameter measurement apparatus (PUF measurement apparatus) generates a challenge C, and transmits that challenge to the PUF device.

2. The PUF device generates a response R by an internal PUF circuit.

3. The PUF measurement apparatus acquires data required to generate operation parameters which represent operation features such as a power or electromagnetic waveform, and processing time of the PUF device during response generation. Note that not all of a power, electromagnetic wave, and processing time are always required to be acquired, and if other operation features can be measured, they may be used. Also, when PUF devices of the same type use common feature data, this step may be skipped.

4. The PUF device transmits the response R to the PUF reader.

5. The PUF reader acquires the response R. In order to extract the PUF parameters and operation parameters, measurements of steps 1 to 5 above are desirably repeated.

6. The PUF measurement apparatus extracts PUF parameters from the relationship between the challenge C and response R acquired in step 1 above, and operation parameters from measurement data of the power or electromagnetic waveform, processing time, and the like. Note that when the PUF device has a sufficient recording capacity, challenge-response pairs, and measured data of the power or electromagnetic waveform, processing time, and the like may be held intact in place of the parameters without executing the extraction processing of the PUF parameters and operation parameters.

7. The PUF measurement apparatus applies a digital signature (or encryption) to the parameters extracted in step 6 above by adding an ID to be assigned to the PUF device. When the ID has already been assigned to the PUF device before PUF parameter measurement at, for example, the time of manufacture of the PF device, that ID may be used. PUF individual identification can be attained by each different challenge-response pair, but it is desirable to assign an ID to the PUF device in terms of handling of the PUF by, for example, an application after identification and convenience upon managing the parameters using a database.

8. The signed parameters are written in the PUF device.

The sequence of authentication processing using this PUF device is as follows.

1. The signed (or encrypted) PUF parameters are transferred from the PUF device to the PUF reader.

2. The PUF reader verifies (or decrypts) the signature of the PUF parameters to confirm if they are valid parameters. If signature verification has failed, the authentication processing is aborted.

3. The PUF reader generates a challenge C (which need not be the same as C at the initialization timing), and transmits that challenge to the PUF device. When challenge-response data are saved in place of the PUF parameters like in the conventional system without extracting any PUF parameters, the PUF reader selects a challenge C from the saved data, and transmits the selected challenge to the PUF device.

4. The PUF reader calculates a response R, which is expected for the challenge C, based on the parameters transferred from the PUF device. When the challenge C selected from the challenge-response data is transmitted without extracting any PUF parameters, the PUF reader selects a response R corresponding to the transmitted challenge C.

5. The PUF device generates a response R′.

6. The PUF reader observes a power waveform (an electromagnetic waveform in case of a wireless communication) consumed by the PUF device during generation of the response R′ and a processing time required to generate the response, and checks whether or not the PUF device performs valid operations which match the operation parameters. If the operations are invalid, the process returns to step 3 above to execute re-processing, or the processing is aborted. (Judgment is made as needed by checking whether measured parameters fall within an allowable range, are on the borderline, or fall outside the range since these measured parameters vary depending on an operation environment)

7. The PUF device transfers the response R′ to the PUF reader.

8. The PUF reader compares the response R′ with the preliminarily calculated expected value R, and returns the process to step 3 above according to a degree of matching so as to execute re-processing or to abort processing. (Judgment is made as needed by checking whether the degree of matching falls within an allowable range, is on the borderline, or falls outside the range since that degree of matching varies depending on an operation environment)

As described in step 6 at the initialization timing, some challenge-response pairs may be acquired at the time of initialization, and may be used in authentication in place of the PUF parameters without extracting any PUF parameters. Unlike in the conventional PUF, the challenges and responses are not for one-time use, but can be used repetitively. That is, the challenge-response correspondence may be allowed to be monitored and simulated by a third person. Whether a valid response, which is returned in response to the challenge, is that which is processed by an authentic PUF device or that which is calculated using a processor or stored in a memory, and is returned by a simulating device is judged by observing processing time and power or electromagnetic waveform during processing. Conversely, even when the processing time and the power/electromagnetic waveform are matched, if responses do not match, that PUF device can be judged as another PUF device which was manufactured by the same LSI process to have the same circuit.

That is, the conventional executes authenticity determination using only response patterns, but the present invention executes the determination from both sides of pattern matching of the responses and the physical operations during response generation. The PUF of the present invention can be easily understood by contrasting it with a fingerprint comparator. Most initial fingerprint comparators execute authentication only by pattern matching, and are cracked by an artificial finger which copies a fingerprint pattern using gelatin or the like. Hence, current fingerprint comparators include a mechanism for accurately identifying whether or not a finger belongs to a living body. This fingerprint pattern matching can be associated with PUF response collation, and biological identification can be associated with observation of the time and power/electromagnetic wave. Unlike fingerprints, vein authentication improves security since it is difficult to steal a venous pattern, and this can be associated with the conventional PUF which makes challenge-response simulation difficult. Although a fingerprint pattern cannot be changed if it is stolen, personal authentication is implemented with high accuracy by combining with biological identification. Likewise, the PUF of the present invention implements valid authentication by observing operations during processing even when a challenge-response pair or parameters required to generate them are monitored by a third person. Since a challenge-response pair can be re-used or a new challenge-response pair can be generated using the parameters, the number of use of a PUF device has no limitation. Even when a response includes a few errors, challenge-response processing is repeated to improve authentication accuracy.

The conventional PUF uses a challenge-response pair having one-to-one correspondence. However, when operation environment of the PUF device, such as power supply voltage or ambient temperature is changed, a different response may be generated for the same challenge. Also, even in the same operation environment, a response may vary due to randomness. Hence, by executing parameter extraction in consideration of these variations caused by the operation environment or by holding challenge-response data corresponding to one-to-many responses, the authentication accuracy can be improved.

“Physically Unclonable” means that a clone having the same structure and the same variations of physical characteristics cannot be generated, and a PUF that allows the simulation of a response is often called “Clonable”. However, satisfying the former condition is a necessary and sufficient condition of the PUF used in the present invention, and the latter condition does not serve as a condition.

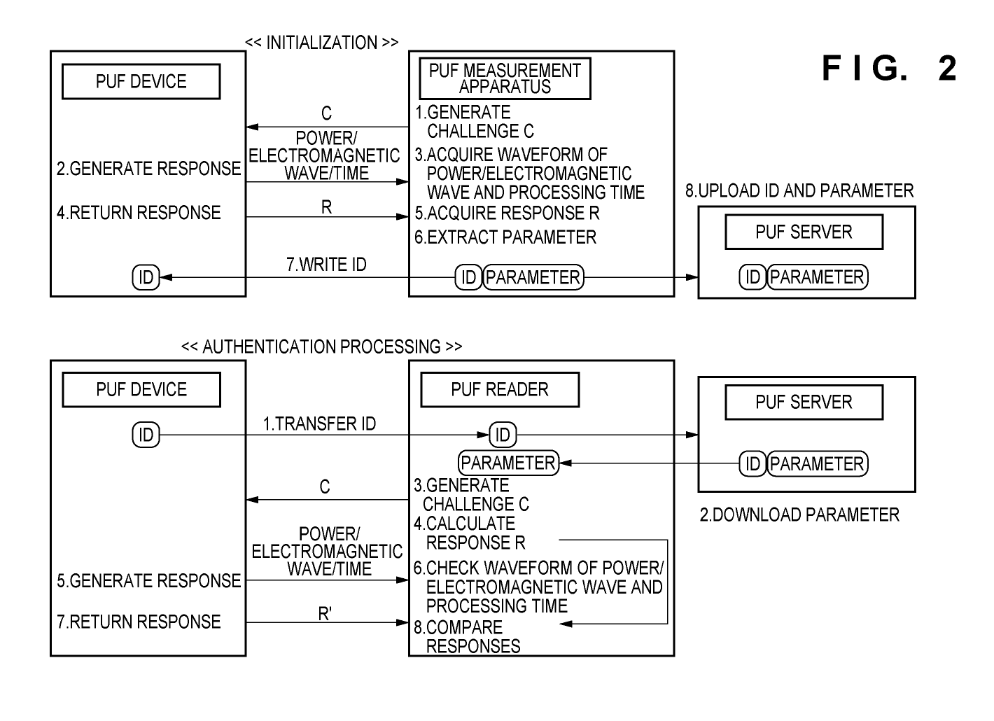

FIG. 2 is a view showing a second example of the authentication method based on the PUF, which embodies the present invention. The present invention allows not only local PUF device authentication but also authentication using a PUF server which holds the PUF parameters as a database, as shown in FIG. 2. In this case as well, unlike in the conventional method, operation features such as a power waveform, electromagnetic waveform, or processing time are checked to implement accurate authentication (authenticity determination). A merit of using the server is that the need for a digital signature of the PUF parameters can be obviated (of course, a signature can be applied). Upon measuring the PUF parameters, only an ID is written in the PUF device, and the PUF parameters are transferred only to the PUF server together with the ID. Since the PUF device is normally possessed by the user, an attacker may rewrite the PUF parameters. Hence, in order to prevent this, a digital signature is required. By contrast, in the second example shown in FIG. 2, since the PUF parameters are downloaded from the PUF server at the time of authentication, the need for this signature can be obviated as long as a secure communication can be made between the PUF reader and PUF server. Note that in place of establishing connection to the PUF server every time individual PUF authentication is executed, the PUF parameters may be downloaded in advance to the PUF reader periodically (for example, when a database is updated).

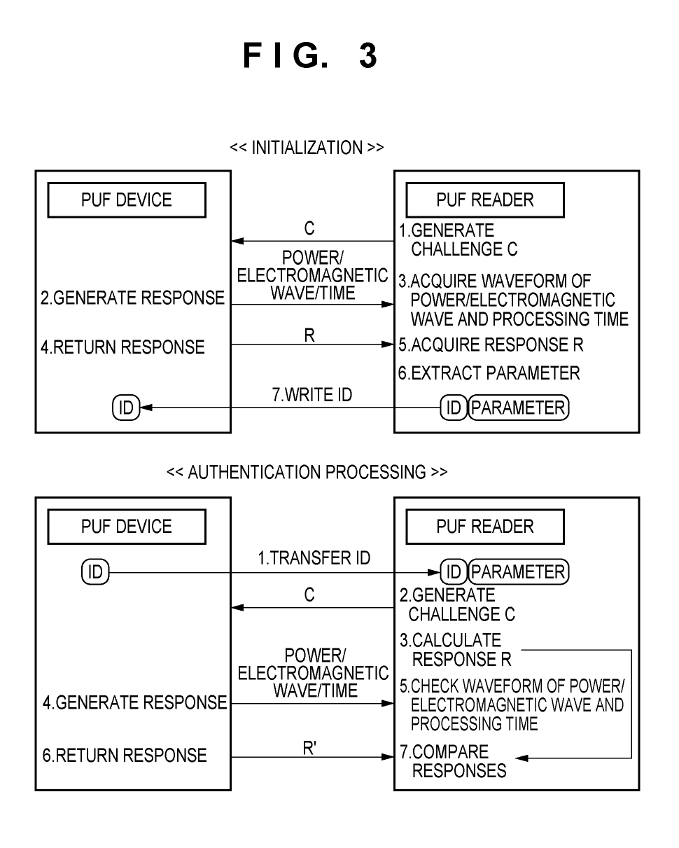

FIG. 3 is a view showing a third example of the authentication method based on the PUF, which embodies the present invention. This third example is suited to use in a relatively small-scale system in which a use range of the PUF device is limited. Since the PUF reader has challenge-response responding and a measurement function of a power/electromagnetic waveform, processing time, and the like, it is used as a measurement apparatus. In this case, since the PUF reader can hold PUF parameters, the need for a digital signature can be obviated, as in the second example. However, only the PUF reader which measures the parameters of the PUF device can execute authentication in this state. Hence, a function of transferring parameters from the PUF reader to another PUF reader is required according to an application.

### EXAMPLE

(Use in IC Card)

As regards practical embodiment of the present invention, use in an IC card is particularly effective. Since an IC card handles very important digital data such as e-money and credit card functions, an encryption technique is used. Secret key information used in that encryption is recorded inside the IC card, and a measure is normally taken to prevent the key information from being read externally. However, such a measure cannot cope with all attacks which directly observe data inside an LSI by reverse engineering using an LSI analysis apparatus and generate an exact copy of said data. Also, a side-channel attack, which analyzes internal operations by measuring a power or electromagnetic wave generated by an encryption circuit and steals a secret key, is a real threat, and an IC card may be forged by writing secret information acquired by means of such an attack on the IC card. Hence, by linking physical characteristics of individual PUF devices and secret information using the PUF technique of the present invention, it becomes impossible to forge the IC card by copying digital data. Since power is supplied from a reader to a contact IC card directly or to a non-contact IC card by electromagnetic induction, it is very easy to monitor an operation waveform at the time of response processing. Such observation technique of a power/electromagnetic waveform has already been established in studies of the side-channel attacks. Also, since the PUF device of the present invention is very simple and compact, it is expected to be used not only in IC cards, which are worth several hundred yen to several thousand yen, but also in RFID tags, which are worth several yen or less, in prospect of market growth. Furthermore, the PUF is also expected to be used as a technique not only for protecting digital data, but also for preventing plagiarism of a circuit pattern itself, such as a dead copy of an LSI.

### INDUSTRIAL APPLICABILITY

The present invention can be used in use applications of preventing forgery of data and IDs in IC cards which handle e-money and RFID tags used in production/distribution management of commodities, in prevention of plagiarism of a circuit pattern of an LSI, and the like.

1. An authentication processing method, which is performed by a PUF device, and a PUF reader which extracts PUF parameters required to calculate a response output from a challenge input by analyzing an operation of the PUF device, extracts operation parameters characterizing an operation state by observing a power waveform, an electromagnetic waveform, or a processing time of the PUF device at that time, and executes authentication of the PUF device based on the extracted parameters,
wherein the PUF reader generates a challenge C, transmits the challenge C to the PUF device, and calculates a first response R, which is expected for the challenge C, based on the PUF parameter,
the PUF device generates a second response R′ based on the challenge C transmitted from the PUF reader, and transfers the second response R′ to the PUF reader,
the PUF reader executes authentication processing by comparing the second response R′ with the preliminarily calculated first response R, and
the PUF reader executes authenticity determination as to whether or not the PUF device is a valid PUF device by monitoring an operation of the PUF device during response generation based on the operation parameters.

2. The authentication processing method according to claim 1, wherein the PUF parameters and operation parameters are extracted by the PUF reader or by an independent PUF measurement apparatus arranged to extract the PUF parameters and operation parameters.

3. The authentication processing method according to claim 1, wherein the PUF parameters are parameters which are obtained by acquiring some pairs of challenges and responses in the PUF device and saving the pairs of challenges and responses as PUF parameters or parameters required to calculate a response to a challenge.

4. The authentication processing method according to claim 3, wherein the saved PUF parameters and operation parameters are saved in the PUF reader to execute local device authentication, or are saved on a PUF server which makes communications via the PUF reader when the parameters are used.

5. The authentication processing method according to claim 3, wherein the saved PUF parameters and operation parameters are applied with a digital signature so as to prevent falsification.

6. The authentication processing method according to claim 1, wherein the PUF reader verifies a digital signature applied to the parameters transferred from the PUF device to confirm if the parameters are valid parameters, and aborts the authentication processing when signature verification has failed.

7. An authentication processing apparatus comprising a PUF device, and a PUF reader which extracts PUF parameters required to calculate a response output from a challenge input by analyzing an operation of the PUF device, extracts operation parameters characterizing an operation state by observing a power waveform, an electromagnetic waveform, or a processing time of the PUF device at that time, and executes authentication of the PUF device based on the extracted parameters,
wherein the PUF reader executes authenticity determination as to whether or not the PUF device is a valid PUF device by monitoring an operation of the PUF device during response generation based on the operation parameters.

8. The authentication processing apparatus according to claim 7, wherein the PUF parameters and operation parameters are extracted by the PUF reader or by an independent PUF measurement apparatus arranged to extract the PUF parameters and operation parameters.
